(19) United States
(12) Patent Application Publication
(10) Pub. No.: US 2007/0291135 A1
(43) Pub. Date: Dec. 20, 2007

(54) Motion characterization sensor

(76) Inventors: Richard L. Baer, Los Altos, CA (US); Aman Kansal, Bellevue, WA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/471,796

(22) Filed: Jun. 20, 2006

(51) Int. Cl. H04N 5/76

(52) U.S. Cl. 348/231.99

(57) ABSTRACT

An image sensor communicates with a microcontroller. A capture timing circuit provides feedback from the microcontroller to the image sensor. The microcontroller bidirectionally communicates with a memory subsystem and a communication interface. A “background learning” technique is applied to the captured images to determine when motion activity has occurred.

### BACKGROUND

Motion detection is used in a wide variety of applications, e.g. automatically opening doors, controlling lights, and detecting intrusion. Prior solutions use passive infra-red sensors, microwave detectors, and combinations thereof. These devices may be considered non-imaging sensors. Such devices include passive infra-red (PIR) sensors, microwave detectors, and combinations thereof.

The aforementioned devices operate similarly. They indicate the presence of motion in their field of view while providing no data as to the location of the motion event or events in the field of view. The reported data solely reflects the motion activity above a pre-set threshold. The presence of motion is detected but not tracked over multiple instances in time. Hence, no information about trajectory or velocity is gathered. These motion sensors do not distinguish between a single or multiple motion events. Thus, a single large mobile object or multiple smaller mobile objects may yield the same output.

PIR-based motion sensors solely detect motion due to thermal sources. The movement of non-living objects do not yield sufficient contrast in a thermal image, and hence may not be detected.

### SUMMARY

An image sensor communicates with a microcontroller. A capture timing circuit provides feedback from the microcontroller to the image sensor. The microcontroller bi-directionally communicates with a memory subsystem and a communication interface. A “background learning” technique is applied to the captured images to determine when motion activity has occurred.

Further features and advantages of the present invention, as well as the structure and operation of preferred embodiments of the present invention, are described in detail below with reference to the accompanying exemplary drawings.

### BRIEF DESCRIPTION OF THE DRAWINGS

FIG. 1 illustrates a functional block diagram of the present invention.

FIG. 2 illustrates a process flow chart corresponding to a motion characterization method.

### DETAILED DESCRIPTION

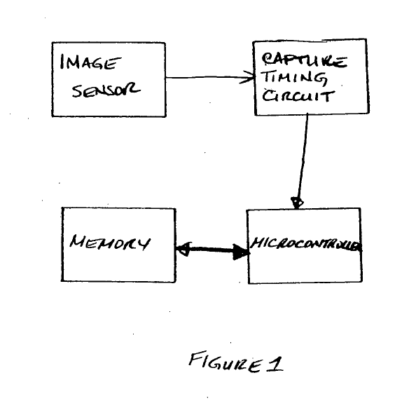

FIG. 1 illustrates a functional block diagram of the present invention. An image sensor communicates with a microcontroller. A capture timing circuit provides feedback from the microcontroller to the image sensor. The microcontroller bidirectionally communicates with a memory subsystem and a communication interface.

In this illustrative example, the image sensor has a 64×64 pixel array for capturing images. The image data is stored in the memory unit and then processed to provide motion characteristics.

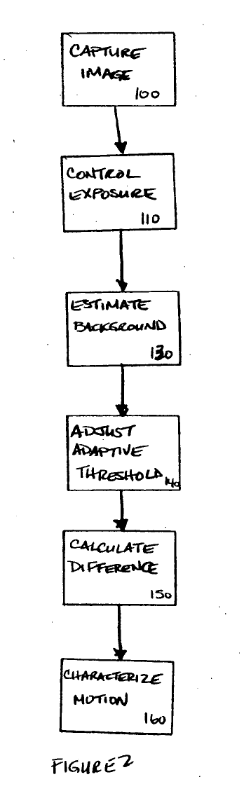

FIG. 2 is a process flow chart corresponding to a motion characterization method.

In step 100, the image is captured.

In step 110, “Exposure Control”, the raw pixel values are altered to provide sufficient contrast to the image among various objects in the field of view.

In step 130, “Background Learning”, the background scene in the field of view with respect to motion detection is estimated. An autoregressive filter is used to continuously adapt the background image. The filter parameters are designed with respect to the expected scene dynamics.

In step 140, “Adaptive Threshold Adjustment”, the spurious motion artifacts, e.g. movements of small objects in the background and noise due to variable textures in the field of view, are filtered out. A difference threshold is chosen individually for all pixels in the image. The threshold is selected such that when a new image is captured and subtracted from the background, the pixels which show a difference value greater than the threshold are considered to represent motion activity. In this embodiment, the threshold value is adapted based on observed motion activity at each pixel. Thresholds are increased at pixels that constantly show difference values above the chosen threshold to desensitize noisy regions. Thresholds are decreased where no motion is detected and sensitivity is thus increased selectivity.

While this step has been described applying the threshold to determine motion activity at each pixel (for a low resolution pixel array), the technique may be extended to that of a pixel grouping when a higher resolution pixel array is employed.

In step 150, “Difference Calculation”, the difference at each pixel or pixel grouping in the current captured image with respect to the learned background is calculated. In one embodiment of the invention, step 140, “Adaptive Threshold Adjustment”, and step 150, “Difference Calculation” occurs simultaneously.

In step 160, “Motion Characterization”, the difference data is used to compute the number of significant motion events, their location, and their extent in terms of area affected. Regions are selectively identified that show motion activity above the adaptively chosen thresholds. The location and size of each region is computed. The number of regions above a particular size is counted. This data is then transmitted over the communication interface to be used by a client application.

Although the present invention has been described in detail with reference to particular embodiments, persons possessing ordinary skill in the art to which this invention pertains will appreciate that various modifications and enhancements may be made without departing from the spirit and scope of the claims that follow.

We claim:

1. A system comprising:
an image sensor;
a microcontroller receiving data from the image sensor;
a capture timing circuit, interposing the microcontroller and the image sensor;
a memory subsystem bidirectionally communicating with the microcontroller.

2. A method comprising:
capturing an image;
adjusting the contrast to indicate objects in the field of view of the image;
estimating the background scene within the current captured image;
filtering motion artifacts from the current captured image according to a threshold parameter;
for a pixel group, calculating a difference between the current captured image and the background scene using image parameters; and
characterizing motion according to the difference between the current captured image and the background scene.

3. A method, as in claim 2, wherein the pixel group is a single pixel.

4. A method, as in claim 2, wherein filtering and calculating a difference occur simultaneously.

5. A method, as in claim 2, the image parameters being selected from a group that includes location of moving objections, size of moving objects, and number of moving objects.
